(19) United States
(12) Patent Application Publication
(10) Pub. No.: US 2007/0094195 A1
(43) Pub. Date: Apr. 26, 2007

(54) Artificial intelligence analysis, pattern recognition and prediction method

(76) Inventor: Ching-Wei Wang, Kaohsiung (TW)

Correspondence Address: Rabin & Berdo, P.C., Suite 500, 1101 14th Street, Washington, DC, 20005, US

(21) Appl. No.: 11/221,879

(22) Filed: Sep. 9, 2005

(51) Int. Cl. G06N 5/02

(52) U.S. Cl. 706/46

(57) ABSTRACT

An artificial intelligence analysis, pattern recognition and prediction method is implemented with software installed in computer hardware to create a system. The method has a classified data inputting act, a first learning act, a building act, an unclassified data inputting act, an analyzing act, a comparing act, an ending act, a transferring act and a second learning act. The comparing act is the comparing of an actual classifier of a testee with a predicted classifier by the system, and results in conformity or nonconformity between the actual class label and the predicted class label. The second learning act is the learning of the new data by the machine learning algorithm when nonconformity is the result of the comparing act. The refining act is the refining of the rules and patterns. The method concludes a predicted result and refines itself when the predicted result is different from an actual result.

### BACKGROUND OF THE INVENTION

1. Field of the Invention

The present invention relates to an analysis and prediction method, and more particularly to an artificial intelligence analysis, pattern recognition and prediction method that analyzes and recognizes data, concludes a predicted result and refines itself when the predicted result is different from an actual result.

2. Description of the Related Art

Recognition devices, such as fingerprint-recognition devices, iris-recognition devices or handwriting-recognition devices, are popularly used. A conventional recognition device has recognition software installed in the device. Data is inputted into the device. The device compares the inputted data with the database stored inside the device, and then gives a result that determines which data in the database the inputted data corresponds to.

However, the recognition device cannot modify nor refine the software to improve the precision of the prediction by learning when a predicted result is different from an actual result. Furthermore, the conventional recognition device processes the inputted data with a low dimensional statistical model and cannot give a precise result when the inputted data includes high dimensional information.

To overcome these shortcomings, the present invention provides an artificial intelligence analysis, pattern recognition and prediction method to resolve the aforementioned problems.

### SUMMARY OF THE INVENTION

The main objective of the invention is to provide an artificial intelligence analysis, pattern recognition and prediction method that analyzes and recognizes data, concludes a predicted result and automatically refines itself when the predicted result is different from an actual result.

An artificial intelligence analysis, pattern recognition and prediction method in accordance with the present invention is implemented with software installed in computer hardware to create a system. The method has a classified data inputting act, a first learning act, a building act, an unclassified data inputting act, an analyzing act, a comparing act, an ending act, a transferring act and a second learning act.

The comparing act is the comparison in an actual class label of a testee with a predicted class label by the system, and results in conformity or nonconformity between the actual one and the predicted one.

The second learning act is the learning of the new data by the machine learning algorithm when nonconformity is the result of the comparing act.

Other objectives, advantages and novel features of the invention will become more apparent from the following detailed description when taken in conjunction with the accompanying drawings.

### BRIEF DESCRIPTION OF THE DRAWINGS

FIG. 1 is a diagram of an artificial intelligence analysis, pattern recognition and prediction system in accordance with the present invention.

FIG. 2 is a diagram of data of the system in FIG. 1.

FIG. 3 is a flow diagram of an artificial intelligence analysis, pattern recognition and prediction method in accordance with the present invention.

### DETAILED DESCRIPTION OF PREFERRED EMBODIMENT

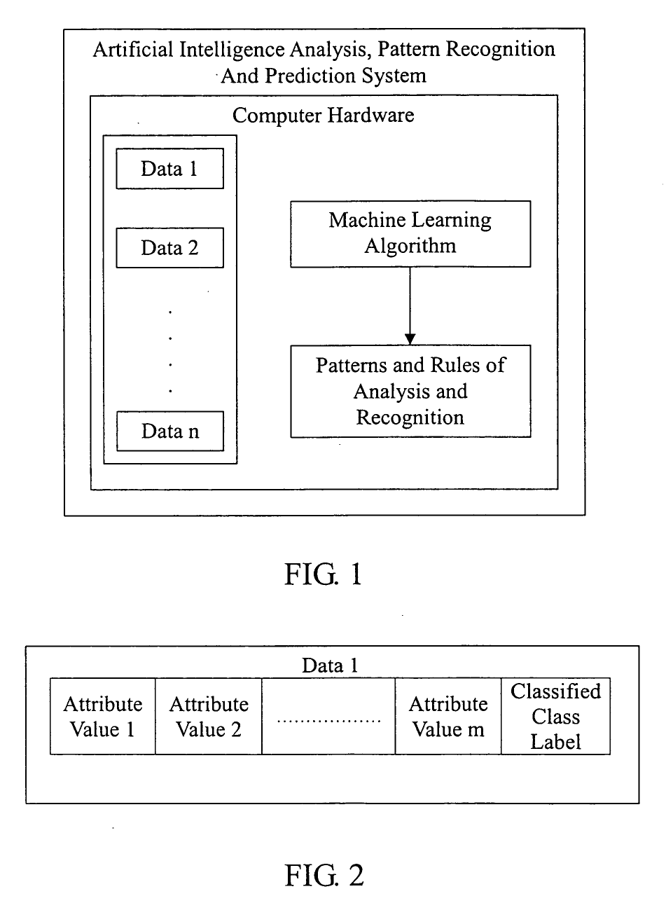

With reference to FIGS. 1, 2 and 3, an artificial intelligence analysis, pattern recognition and prediction method in accordance with the present invention is implemented with software installed in computer hardware to create an artificial intelligence analysis, pattern recognition and prediction system.

The system may be used to predict a disease according to a set of genes of a person, to recognize images such as faces, irises, fingerprints, to recognize voiceprints and to predict credit risks or other financial affairs.

The software is compiled according to a machine learning algorithm. The classic definition of machine learning (Mitchell, T. [1997] Machine Learning. McGraw Hill) is as follows: A computer system is said to learn from some experience E with respect to some class of tasks T and performance measure P, if it improves its performance (as measured by P) at tasks in T after passing the experience E. The goal of machine learning is to develop techniques that allow computers to discover knowledge and develop strategies on their own.

A preferred embodiment of the machine learning algorithm is a bootstrapping-boosting algorithm and has following contents:

Inputs:
1. A training set T<X, Y>, where X represents the instances and Y are the classes.
   X: a set of instances: {x|x<a₁, . . . , a_{q}>}, where a is an attribute value and q is the number of attributes.
   Y: a set of classes (with z different classes).
   T: {<x₁, y₁>, . . . , <xₙ, yₙ>|xεX, yεY}, where n is the size of the training set.
2. Number of base classifiers R.
3. The limit value of bootstrap times.
4. Base Learner/Inducer.

Output:
1. The boosted model: Function C*.

Steps:
* * Initialize instances' weights (Normalization)
1. For i=1 to n
   1.1 Weight: W₁(i)=1/n
2. Generate a copy of the training data for constructing base classifiers: S (the training data will be used for evaluation whereas S is used for building a base classifier and its instances' weights will be changed in every construction.)
3. For r=1 to R, repeat:
   3.1 Bootstrap S data set from previous round S data set.
   3.2 Build a new Classifier Cᵣ(X) using weighted S data set (X, Wᵣ) by base learner.
   3.3 Compute the error rate by evaluating the base classifier Cr(X) with training data.
   Error rate Sum of the weights of the instances, which are misclassified by the base classifier Cᵣ(X).
   3.4 If the error rate is equal to 0 and the bootstrap times is less than the bootstrap limit, go back to 3.1 to do the bootstrap.
   3.5 Stop if the error is greater than 0.5 or equal to 0.
   3.6 Bᵣ=error rate/(1−error rate),
   * * Set sum of instance weights for next round to 0.
   3.7 Sum Wᵣ₊₁=0,
   * * Update instances' weights.
   3.8 For i=1 to n,
      3.8.1 If Cᵣ misclassifies instance i, Wᵣ₊₁(i)=Wᵣ(i)*
      Else, Wᵣ₊₁(j)=Wᵣ(i).
      3.8.2 Sum Wᵣ₊₁=Sum Wᵣ₊₁+Wᵣ₊₁(j),
* * Normalize instances' weights.
   3.9 For i=1 to n,
      3.9.1 Wᵣ₊₁(i)=Wᵣ₊₁(i)/Sum Wᵣ₊₁
4. Produce the arced model Function C* (instance) by Voting.
5. Return Function C*.

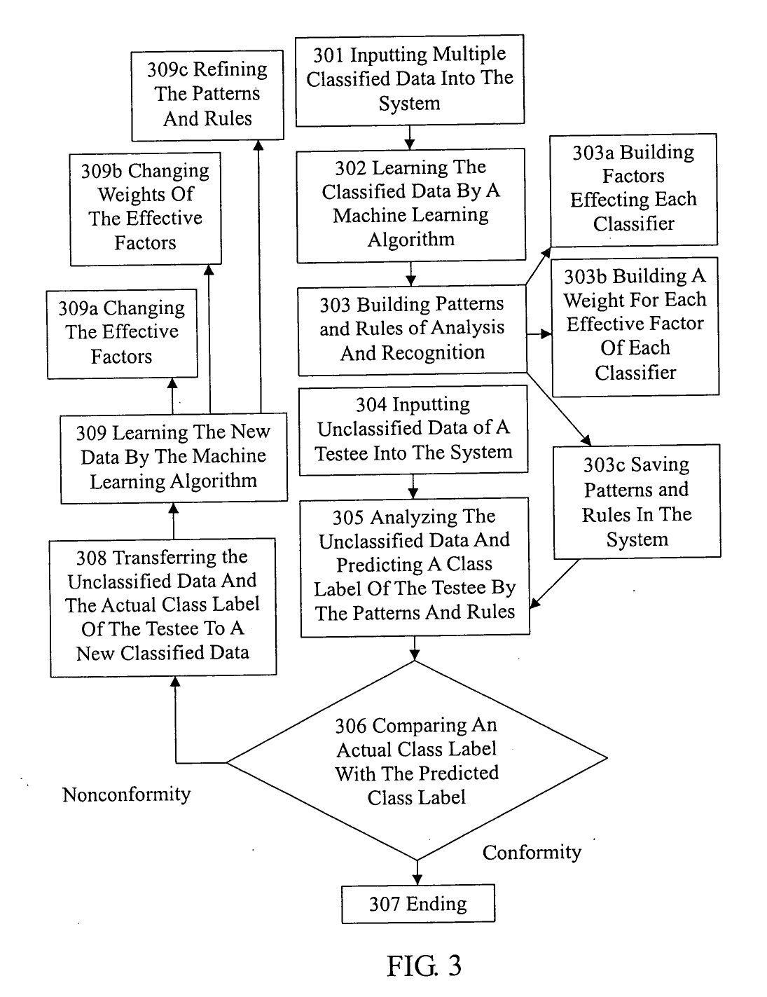

With reference to FIG. 3, the artificial intelligence analysis, pattern recognition and prediction method comprises a classified data inputting act (301), a first learning act (302), a building act (303), an unclassified data inputting act (304), an analyzing act (305), a comparing act (306), an ending act (307), a transferring act (308) and a second learning act (309).

The classified data inputting act (301) is the inputting of multiple classified data, such as Data 1-n shown in FIG. 1, into the artificial intelligence analysis, pattern recognition and prediction system. For instance, each data represents a set of genes, and has multiple attribute values, such as Attribute Values 1-m, and a class label, as shown in FIG. 2. The attribute values respectively represent the genes. The class label is a result of cell-variation, and may be that of a normal cell or a cell suffering from lung cancer, or may be a cell suffering from AML-type leukemia, ALL-type leukemia or MLL-type leukemia.

The first learning act (302) is the learning of the classified data by the machine learning algorithm in the form of software. The machine learning algorithm may be the aforementioned bootstrapping-boosting algorithm or the like.

The building act (303) is the building of patterns and rules of analysis and recognition according to what is learned by the machine learning algorithm and has a factor-building act (303a), a weight-building act (303b) and a saving act (303c). The patterns and rules constitute a classifier, generated by the machine learning algorithm. The factor-building act (303a) is the building of multiple effective factors for the classifier. For instance, factors are five of the aforementioned attribute values 1-m. They influence the cell-variation result. The weight-building act (303b) is the building of multiple weights corresponding to the effective factors of the classifier. For instance, the weights of the five attribute values 1, 3, 5, 7 and 9 are 20%, 20%, 20%, 10% and 30%, respectively. The saving act (303c) is the saving of patterns and rules in a database of the system.

The unclassified data inputting act (304) is the inputting of the unclassified data of a testee into the system with unknown class label. For instance, the inputted unclassified data is a set of genes of a cell without knowing its leukemia type, i.e. AML, ALL or MLL.

The analyzing act (305) is the analysis of the unclassified data of the testee and predicting the class label of the testee by using the patterns and rules/classifier.

The comparing act (306) is to compare the actual class label with the predicted class label to determine conformity or nonconformity. For instance, the actual class label represents a cell suffering from MLL-type leukemia.

The ending act (307) is the ending of the method when conformity is the result of the comparing act (306).

The transferring act (308) is the transferring of the unclassified data and the actual class label of the testee to a new classified data when nonconformity is the result of the comparing act.

The second learning act (309) is the learning of the new data by the machine learning algorithm and has a factor-changing act (309a), a weight-changing act (309b) and a refining act (309c). The factor-changing act (309a) is the increasing and/or decreasing of factors to affect a corresponding classifier. The weight-changing act (309b) is the changing of the weight of each factor for a corresponding classifier. For instance, the original effective attributes are the 1^{st}, 3^{rd}, 5^{th}, 7^{th} and 9^{th} features. The further modification is achieved by adding another attribute, such as the 11^{th} feature, and reassigning weights for each attribute. The refining act (309c) is the refining of the rules and patterns. It includes factor-changing act and weight-changing act.

When the artificial intelligence analysis, pattern recognition and prediction method is used to recognize a human face, the classified data may be a two-D static facial image, a three-D dynamic facial image or a four-D facial dynamic image with a person identity information. The classified data has multiple attribute values respectively representing partial images of the whole image, such as eyes, ears, a nose and a mouth. The system will give a predicted class label in identification for an inputted unclassified facial image.

When the artificial intelligence analysis, pattern recognition and prediction method is used to recognize a voiceprint, the classified data is a sound spectrum with a class label of identification. The classified data has multiple attribute values representing partial sound spectrums. The system will give a predicted class label of identification for an inputted unclassified sound spectrum.

When the artificial intelligence analysis, pattern recognition and prediction method is used to analyze a credit risk, the classified data is a financial statement of a person with a numeric value or nominal class label of credit risk. The classified data has multiple attribute values respectively representing personal information, the amount of debts and reimbursements. The system will give a predicted class label showing the degree of credit risk.

The intelligent system is able to improve itself by automatically adjust its rules and patterns. By refining the classifier when a predicted class label of the unclassified data is different from an actual one, the next prediction provided by the system will be more and more precise.

Even though numerous attributes and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An artificial intelligence analysis, pattern recognition and prediction method implemented with software installed in computer hardware to create an artificial intelligence analysis, pattern recognition and prediction system, and comprising:
a classified data inputting act being inputting of multiple classified data into the system;
a first learning act being learning of the classified data by the machine learning algorithm;
a building act being building of patterns and rules for analysis, prediction and recognition according to the what is learned by the machine learning algorithm;
an unclassified data inputting act being inputting of unclassified data of a testee into the system;
an analyzing act being analysis of the unclassified data of the testee and predicting a class label of the testee by using the patterns and rules;
a comparing act being inputting of an actual class label of the unclassified data of the testee into the system and comparing the actual class label with the predicted class label to determine conformity or nonconformity;
an ending act being ending of the method when conformity is the result of the comparing act;
a transferring act being transferring of the unclassified data and the actual classifier of the testee to a new classified data when nonconformity is the result of the comparing act; and
a second learning act being learning of the new data by the machine learning algorithm.

2. The method as claimed in claim 1, wherein the building act further having:
a factor-building act being building of multiple effective factors for the preconstructed classifier generated by building act;
a weight-building act being building of multiple weights corresponding to the effective factors of the classifier; and
a saving act being saving the patterns and rules in the system.

3. The method as claimed in claim 1, wherein the second learning act having:
a factor-changing act being increasing and/or decreasing of factors to effect a corresponding classifier;
a weight-changing act being changing of the weight of each factor for a corresponding classifier; and
a refining act being refining of the rules and patterns.
